(19) United States
(12) Patent Application Publication
(10) Pub. No.: US 2005/0211351 A1
(43) Pub. Date: Sep. 29, 2005

(54) Tire with detectable carcass cushion layer and use thereof to facilitate tire carcass retreading

(76) Inventors: Ramendra Nath Majumdar, Hudson, OH (US); Kiyoshi Ueyoko, Akron, OH (US); Piet Vermaat, Mertzig (LU)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/061,217

(22) Filed: Feb. 18, 2005

Related U.S. Application Data
(60) Provisional application No. 60/556,135, filed on Mar. 24, 2004.

(51) Int. Cl. B60C 11/02; B60C 11/24; B29D 30/54; B29D 30/52

(52) U.S. Cl. 152/154.2; 156/96; 152/209.6; 156/64; 152/532

(57) ABSTRACT

This invention relates to a retreadable tire which contains a non-black colored rubber carcass cushion layer sandwiched between its tire tread and tire casing. The non-black colored rubber carcass cushion layer acts both as an adhesive and transition layer for adhering a cured or uncured tire tread to the cured tire carcass. Such carcass cushion layer also acts as a detectable color indictor for indexing and monitoring a complete removal (e.g. by buffing, abrading, or cutting) of the circumferential rubber tire tread and partial removal of the carcass cushion layer without removing the entire carcass cushion layer. The invention also relates to a method of retreading a cured rubber tire carcass by completely removing a circumferential, carbon black reinforced (and therefor a black colored) tire rubber tread together with a partial removal of the contrastingly colored cured rubber carcass cushion layer to a depth indexed and/or determined by an automated rubber cushion layer color sensing means, or apparatus, followed by applying a non-black colored uncured circumferential rubber carcass cushion layer and carbon black reinforced (therefore black colored) tire tread thereon to form an assembly thereof and vulcanizing the assembly in a suitable mold to form a retread tire.

The Applicants hereby incorporate by reference prior U.S. Provisional Application Ser. No. 60/556,135, filed on Mar. 24, 2004.

### FIELD OF THE INVENTION

This invention relates to a retreadable tire which contains a non-black colored rubber carcass cushion layer sandwiched between its tire tread and tire casing. The non-black colored rubber carcass cushion layer acts both as an adhesive and transition layer for adhering a cured or uncured tire tread to the cured tire carcass. Such carcass cushion layer also acts as a detectable color indictor for indexing and monitoring a complete removal (e.g. by buffing, abrading, or cutting) of the circumferential rubber tire tread and partial removal of the carcass cushion layer without removing the entire carcass cushion layer. The invention also relates to a method of retreading a cured rubber tire carcass by completely removing a circumferential, carbon black reinforced (and therefor a black colored) tire rubber tread together with a partial removal of the contrastingly colored cured rubber carcass cushion layer to a depth indexed and/or determined by an automated rubber cushion layer color sensing means, or apparatus, followed by applying a non-black colored uncured circumferential rubber carcass cushion layer and carbon black reinforced (therefore black colored) tire tread thereon to form an assembly thereof and vulcanizing the assembly in a suitable mold to form a retread tire.

### BACKGROUND OF THE INVENTION

Various colored tread wear indicators have been proposed for tire treads to visually indicate when a tire tread is sufficiently worn away so that the tire's useful tread life has been met. For example, see U.S. Pat. Nos. 6,220,199 and 3,814,160.

However, for retreading of tires, it is desired to completely abrade away the tread so that such colored tread wear indicators are considered herein to be inappropriate for the retreading of tires.

Cord reinforced rubber plies underlying the tire tread have been proposed and sometimes used to aid a retreader in visually determining the degree of buffing away the tread in preparation for a tire retreading operation (e.g. the tread is buffed away until the cords of the aforesaid underlying rubber ply is detected). For example, see U.S. Pat. Nos. 5,088,538 and 4,454,903.

However, it is desired herein to provide an improvement over such tire retread preparation process.

It is envisioned by this invention to create and utilize a non-black colored color indicator in a form of a rubber cushion layer beneath and underlying the tire tread which can be visually and/or electronically detected and utilized to index and/or otherwise control the depth of rubber removal from the tire without having to guess the degree of complete tread removal by relying upon a tread wear indicator positioned within the tread or to speculate a degree of cushion layer removal by looking for an appearance of a cord reinforced ply positioned beneath the tread.

The uncured carcass cushion rubber layer is in a nature of a laminate which may be individually applied to an uncured or cured tire carcass or applied to an uncured tire tread strip or, alternately, laminated to an uncured tread strip as the tread strip is being extruded to shape and contour the tread strip. It is to be appreciated that the tread strip itself may be of a co-extruded cap/base configuration where the carcass cushion rubber layer is laminated to the base layer of the cap/base configured tread strip.

In practice, various tires are sometimes retreaded to replace their existing worn tread with a new tread. For example, aircraft tires and some heavy duty truck tires are sometimes retreaded. For the retreading operation, the existing tread, along with (if any) an underlying circumferential reinforcing belt and rubber cushion layer, is conventionally ground, or cut, away to reveal an underlying carcass which may be composed of a plurality of cord reinforced rubber layers, or plies. A new tire tread is then usually applied to the prepared tire carcass with a cushion rubber layer positioned between the tread and tire carcass as a transition layer between the tire carcass and new tire tread.

If desired, a cord reinforced rubber ply is positioned between the tire tread and carcass cushion layer in order, for example, to added stability to the tire tread/carcass cushion layer composite.

The resulting assembly is then suitably cured to provide the retreaded tire.

In practice, it is desired that a portion of the tire carcass itself is not unnecessarily ground or cut away so that the integrity of the original tire carcass is largely preserved and to thereby promote an opportunity for the retreading of the tire.

Accordingly, it is desirable to provide a means of advantageously identifying a limitation or extent of such grinding, or cutting, in a manner which can be suitably indexed, or robotically administered by a contrasting color sensitive apparatus to effectively control such tread removal operation in combination with providing a suitable cushion/adhesive rubber layer for a retreaded tire.

In U.S. Pat. No. 5,503,940, a carbon black reinforced (black colored) cushion layer for retreading a tire is used with built-in tack for which an application of a tack enhancing cement to the buffed tire carcass was not needed. A bis-imide was used in the cushion composition to provide resistance to blow-outs (formation of voids in the rubber) due to internal heat generation during use and operation of the retreaded tire.

Subsequently, U.S. Pat. No. 6,186,202 also provided a rubber cushion layer for use in the retreading of a tire in which a dispersion of a particulate silica in the rubber cushion layer is used to retard or prevent blow-outs (formation of internal voids with the rubber composition) due to lower internal heat generation of during use and operation of the retreaded tire. Such blow-outs are evidenced by small voids formed in the rubber composition and are a known phenomenon to those having skill in such art.

However, consistent and convenient detection, and/or indexing of the degree of removal of the rubber cushion layer is not readily accomplished for such aforesaid black colored cushion layers.

For this invention, the rubber carcass cushion layer contains an amorphous silica (preferably precipitated silica), reinforcing filler, carbon black-free silica coupling agent, pigment colorant for the carcass cushion rubber of a color other than black and which contains less than 0.5 phr of and is preferably exclusive of, carbon black so that the carbon black itself does not unnecessarily blacken the rubber composition. The non-black colored rubber carcass cushion layer composition also contains a titanium dioxide pigment, which may constitute said pigment colorant, and which promotes a high degree of color contrast and tends to prevent or retard discoloration of the rubber cushion layer upon aging. The adhesive non-black colored rubber carcass cushion layer is adhered to a cured or uncured tire tread and buffed cured tire casing, or carcass, without the need of a cement.

The term “phr” where used herein means “parts per weight of a specified material per 100 parts by weight rubber, or elastomer, in a rubber composition”.

### SUMMARY AND PRACTICE OF THE INVENTION

In accordance with this invention, a method of preparing a tire comprises the steps of:
(A) preparing a tire assembly by application of an uncured, tacky, non-black colored (basically carbon black-free and therefore contains less than 0.5 phr of, and is preferably essentially exclusive of, carbon black) rubber carcass cushion layer as an intermediate transition laminate positioned between an uncured circumferential tire carbon black reinforced rubber tread and a supporting toroidal shaped, carbon black reinforced pneumatic tire rubber carcass, wherein said uncured rubber cushion provides an adhesive bond between said circumferential tire tread and supporting tire carcass, followed by;
(B) curing said prepared tire assembly at an elevated temperature in a suitable mold to form said tire.

In practice, said non-black colored intermediate transition rubber carcass cushion laminate, or layer, by the nature of its non-black color, provides a color based monitoring means for controlling a subsequent removal (e.g. by abrading grinding, buffing and/or cutting away) of the entire cured rubber tread and partial removal of said carcass cushion laminate, or layer.

In one aspect of this invention, a tire is provided which is prepared by such method.

In a further aspect of the invention a new, unretreaded tire is provided having such detectable, non-black colored rubber carcass cushion layer positioned between its circumferential rubber tread and its rubber carcass casing which is useful for a tire retreading method which is hereinafter described.

In an additional aspect of the invention, one or more (usually from 1 to 3) circumferential cord reinforced rubber ply (plies) is (are) positioned between said tire tread and said carcass cushion layer, or laminate.

In a further aspect of the invention, said tire tread is of a co-extruded cap/base configuration with an outer cap rubber layer having a running surface for said tire and an underlying tread base rubber which is not (is exclusive of) said carcass cushion rubber layer.

In an additional aspect of the invention, a retreaded tire is provided by said hereinafter described tire retreading method.

Therefore, in one aspect, a tire is provided which is comprised of a carbon black reinforced, and thereby black colored, rubber carcass and circumferential carbon black reinforced, and therefore black colored, rubber tread characterized in that said tire contains a means of controllably determining a complete removal of said tire tread wherein said means consists of an inclusion of a color-detectable circumferential non-black colored rubber carcass cushion layer, or laminate, between said tire carcass and said tire tread.

It is important to appreciate that, in one aspect of the invention, said non-black colored carcass rubber cushion is designed to enable the entire tire tread to be removed during a tire retreading process, or operation, in a manner to avoid removing a part of the tire carcass itself in which the non-black colored rubber carcass cushion layer is a color discernable layer between said tire tread and tire carcass of which less than the entire rubber carcass cushion layer can be removed coincidentally with the removal of the entire tire tread. Thus, it is to be appreciated that, if the tire tread should be of a cap/base construction composed of a co-extruded outer cap layer with the tire running surface and the tread base rubber layer underlying the tread cap layer, all of carbon black reinforced rubber compositions and therefore of a black color, for a tire retreading process or operation, it is intended that the entire tread, including all of the tread cap layer and tread base layer, be removed and that the non-black colored carcass cushion layer is only partially removed.

In further accordance with this invention, a method of retreading said tire, comprises the steps of:
(A) mounting said cured tire comprised of said black colored circumferential rubber tread, non-black-colored rubber carcass cushion layer laminate underlying said tread, and black colored tire rubber carcass on a suitable apparatus for rotation about its center axis;
(B) inflating the tire with fluid (e.g. air) under pressure greater than ambient atmospheric pressure;
(C) removing (e.g. abrading grinding, buffing and/or cutting away) the entire circumferential tread and partial removal of a portion of said non-black colored carcass cushion layer while rotating said tire about its axis;
(D) wherein the extent of said partial removal of said carcass cushion rubber layer is controlled by a combination of detecting the presence of the non-black color thereof by a color-sensing means and monitoring the extent of its removal to thereby prevent its complete removal from said tire carcass;
(E) applying an uncured, tacky, non-black colored additional rubber carcass cushion layer to the remaining portion of said cured carcass cushion layer on said tire carcass to form a built-up carcass dual cushion layer laminae comprised of a laminate of said uncured cushion layer positioned over (radially outward of) said cured carcass cushion layer;
(F) applying an uncured circumferential carbon black reinforced, black colored rubber tread to the outer surface (radially outer, exposed surface) of said uncured non-black colored carcass cushion layer of said dual cushion laminae to form a tire assembly followed by:
(F) curing said prepared tire assembly at an elevated temperature in a suitable mold to form said retreaded tire.

Therefore, a significant aspect of the invention is an enablement of one aspect of said method of retreading a tire by removal (e.g. by abrading, grinding, buffing and/or cutting away) the entire circumferential black colored rubber tire tread followed by a combination of sensing the underlying non-black colored carcass cushion layer as an intermediate laminated (not co-extruded) layer positioned between said circumferential black colored rubber tread and said black colored rubber tire carcass and controlling the degree (e.g. the depth) of partial removal of a portion of said non-black colored carcass cushion layer in a manner to prevent a complete removal of said carcass cushion layer.

In practice, the rubber composition of said carcass cushion layer is comprised of at least one diene-based elastomer, reinforcing filler as a precipitated silica, carbon black-free coupling agent for said silica and a pigment based non-black colorant comprised of titanium dioxide inorganic pigment and wherein said rubber composition is exclusive of carbon black.

In the description, the non-black colored cushion layer is referred to herein as a carcass cushion layer since it is a laminate which is significantly aligned with the carcass casing in a manner that it seems appropriate to not refer to it as a tire tread base layer since it is not co-extruded with the tire tread.

### BRIEF DESCRIPTION OF THE DRAWING

FIG. 1 is provided as a partial cross-section of a tire depicting a laminate of an uncured tire tread, cured tire carcass and a white colored rubber carcass cushion layer positioned therebetween.

FIG. 2 is provided as a partial cross-section of the tire of FIG. 1 wherein the assembly of the tire tread layer, carcass cushion layer and tire carcass has been cured.

FIG. 3 and FIG. 3A depict a partial tire retreading operation for a worn tire tread partial cross-section.

### THE DRAWINGS

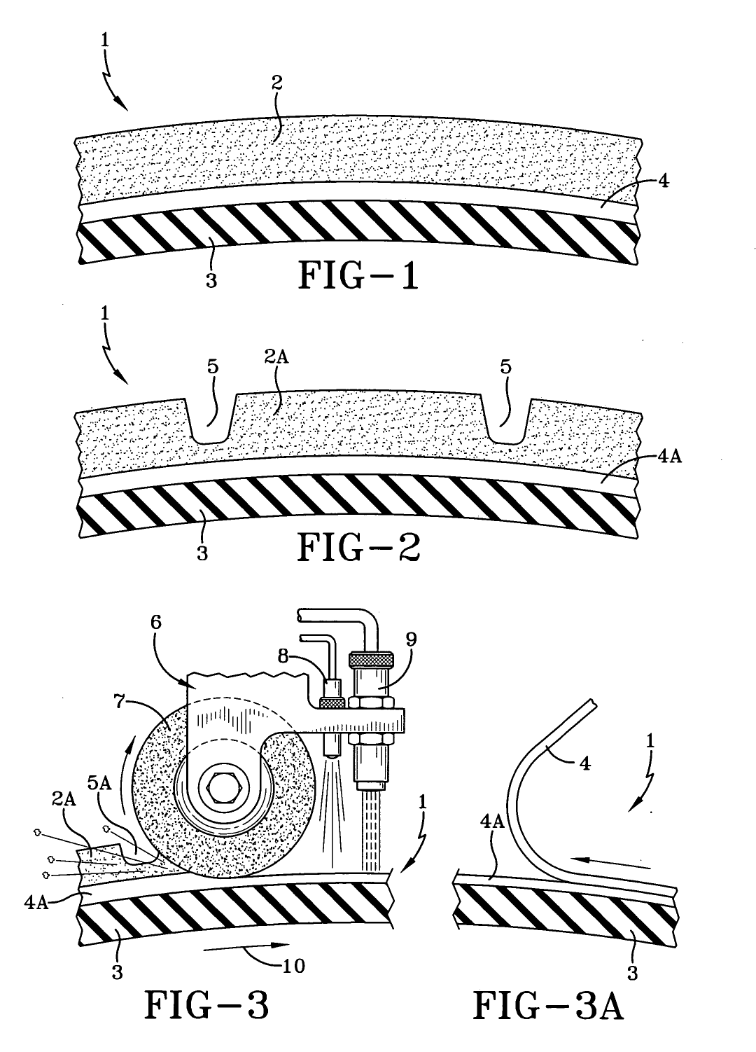

In FIG. 1, a partial cross-section of a tire (1) is depicted which is comprised of a laminate of a carbon black reinforced, black colored, cured rubber carcass (3), a circumferential uncured carbon black reinforced, black colored tread layer (2) and an underlying circumferential non carbon black-containing, silica reinforced and titanium dioxide-containing white colored uncured rubber carcass cushion layer (4) positioned between said tread layer (2) and said tire carcass (3).

In FIG. 2, a partial cross-section of the tire (1) of FIG. 1 is depicted where said laminate, or assembly of laminae, has been cured in a suitable mold at an elevated temperature to so that the tread (2A) is cured with a configuration of lugs and grooves (5) with the cured intermediate rubber carcass cushion layer (4A) cured located between said cured tread (2A) and tire carcass (3).

In FIG. 3, a partial simplified retreading operation is depicted in which the tire is rotated in direction (10) while a cylinder with a plurality of cutting blades, illustrated however in FIG. 3 as a grinding wheel (7), which in practice may be a wheel on which a plurality of metal cutting blades of a multiplicity of different orientations are mounted, is applied by a suitable means (6) against the worn cured rubber tire tread (2A) as evidenced by a reduced tread groove depth (5A) to remove all of the tread (2A) and a partial removal of a portion, but not all, of the cured carcass cushion layer (4A) to a controlled depth administered by a cooperative combination of sensing color sensing means (8) which senses the contrastingly white colored carcass cushion layer (4A) and depth of carcass cushion layer removal determining means (9) which controls the depth of partial removal (e.g. by grinding or cutting away) the cured carcass cushion layer (4A) to prevent the carcass cushion layer from being completely removed and thereby prevent the radially outer surface of the tire carcass (3) from being exposed.

FIG. 3A illustrates application of an additional fresh, uncured white colored rubber carcass cushion layer (4) over the radially outer surface of the partially removed white colored cured carcass cushion layer (4A) to form a carcass cushion layer laminae of the two layers, following which a circumferential uncured, carbon black reinforced, black-colored, rubber tread layer (not shown) is applied to the radially outer surface of the additional uncured carcass cushion layer form a retreaded tire assembly (not shown). The tire assembly is then molded and cured in a suitable mold at an elevated temperature to form the retreaded tire (not shown).

In one aspect of the practice of the invention, an inherently tacky rubber carcass cushion layer (via a tackifying resin such as a phenolic resin inclusion in its uncured rubber composition) is adhered directly to the tire casing without the need of application of a tack enhancing cement to the cushion layer itself so that an intervening coating, or layer, of an adhesive, or cement, or other bonding layer, is not utilized.

Representative of such conjugated diene-based elastomers for use in the tire carcass, carcass cushion layer and circumferential rubber tread are various combinations of elastomers such as, for example polymers and copolymers of dienes of at least one of isoprene and 1,3-butadiene and copolymers of styrene and at least one of isoprene and 1,3-butadiene. Such elastomers are generally blended with various compounding ingredients such as, for example, reinforcing fillers as hereinbefore discussed, zinc oxide, stearic acid, sulfur, accelerators, antioxidants, antiozonants and the like in conventional amounts.

Representative of such elastomers are, for example, cis-1,4-polyisoprene, cis-1,4-polybutadiene and styrene-butadiene rubbers and blends thereof.

Representative of such elastomer blends for said cushion layer are, for example, elastomer blends comprised of about 15 to about 70, alternatively from about 30 to about 50, phr of natural cis-1,4-polyisoprene rubber and, correspondingly, from about 30 to about 85, alternately about 50 to about 70, phr of cis-1,4-polybutadiene rubber.

An important aspect of the present invention is the use of synthetic amorphous silica, preferably precipitated silica, as a reinforcing agent which may be used in an amount of, for example, from about 25 to about 80, alternately about 40 to about 60 phr.

A silica coupling agent is used which has a moiety which is reactive with hydroxyl groups (e.g. silanol groups) contained on the silica, particularly precipitated silica and another moiety which is interactive with said diene-based elastomer(s). For example, a suitable coupling agent may be a bis(3-trialkoxysilylalkyl) polysulfide having from 2 to 8 sulfur atoms, with an average of from 2 to 4 sulfur atoms in its polysulfidic bridge, exemplary is a bis(3-triethoxysilylpropyl) polysulfide. Other coupling agents may be, for example, organoalkoxymertaptosilanes such as for example, mercaptopropyltrimethoxysilane, and mercaptopropyltriethoxysilane. The amount of the sulfur-containing alkylene alkoxy silane compounds of the present invention may vary, for example, from about 0.01 to about 0.2 weight percent of the silica. The coupling agent is used without (exclusive of) a carbon black carrier so that the cushion layer may be on a non-black color.

An example of a coupling agent is carbon black-free Si266™ from Degussa as bis-(3-triethoxysilylpropyl) polysulfide having an average of about 2.2 connecting sulfur atoms in its polysulfidic bridge.

The adhesive carcass cushion layer for the invention is normally desired to have a built-in or inherent tack and therefore can be combined with the carcass and the tread without the need of additional cement. In practice, the carcass cushion layer is therefore desirably intended to be applied in an essentially a solventless form, that is, substantially free of solvent inasmuch as they generally have five parts by weight or less, desirably three, two, or one parts by weight or less, and preferably nil, i.e., completely free, of any volatile organic compounds (VOC), per 100 parts by weight of rubber (phr).

In addition to the rubber, silica, and the coupling agent, the rubber composition of the carcass cushion layer can optionally but preferably include one or more compatible tackifying agents which are utilized in an effective amount to promote good tack (e.g., pressure sensitive tack) with vulcanized elastomeric substrates and also with uncured, vulcanizable elastomeric substrates (i.e. non-vulcanized or at least substantially non-vulcanized). Hence, it is intended that the carcass cushion layer can be applied wrinkle free to a buffed tire casing. Various tackifying resins which can be utilized are generally well known to the art and in the literature which generally include rosin and its derivatives and various hydrocarbon resins. The rosin group comprises rosins, modified rosins and their various derivatives such as esters. The hydrocarbon resin group comprises polyterpines, synthetic hydrocarbon resins, and various modified or special resins which are primarily phenolics. Examples of rosin tackifiers include gum rosin, wood rosin, tall oil rosin, and the like. Such rosins are generally a mixture of organic acids and often referred to as rosin acids. Minor components in the rosin resin include rosin esters and anhydrides, unsaponifiable matter, and fatty acids. The rosin acids can be divided into two different groups, abietic acid type and primaric acid type. The various rosin acids can be reacted with a variety of alcohols to form esters thereof.

Hydrocarbon tackifier resins are low molecular weight polymers derived from crude monomer streams. Steams can be obtained from wood, coal, or petroleum sources. Hydrocarbon resin streams can be classified as containing primarily aromatic, aliphatic, and diene (cyclic olefin) monomers. Polymerization of such streams is generally carried out using a Lewis acid catalyst or by a free-radical process using heat and pressure. The aromatic hydrocarbon resins generally contain aromatic petroleum resins and resins from coal tar, commonly called coumarone-indene resins. The various aliphatic hydrocarbon resins are produced from light, so called carbon-5 petroleum fractions wherein the principal monomers are cis- and trans-piperylene. Other hydrocarbon resins include mixed aliphatic-aromatic resins as well as terpene resins.

Preferred tackifiers are phenol-formaldehyde resins, although other rubber tackifiers can be used in combination or as a substitute therefor. Details of such tackifiers may be found, for example, in the Handbook of Pressure-Sensitive Adhesive Technology, edited by Donatas Satas, Van Nostrand Reinhold Company, 1982, Chapter 16, Pages 353 through 369, which is hereby fully incorporated by reference.

Thus, a preferred type of tackifier is represented by various phenol-formaldehyde resins. Such resins generally have a number average molecular weight of 2,000 or less. Typically, alkyl phenols are used rather than phenol itself since the alkyl group improves the miscibility of the resin with the rubber. Thus, alkyl groups having from 1 to 15 carbon atoms such as butyl, octyl, and nonyl, have been attached to the phenolic nucleus. The manufacture of phenolic resins generally include the condensation of the alkyl phenol with formaldehyde to produce the phenolic resins. Since the phenol has three reactive positions, it will form insoluble resins when more than one mole of formaldehyde is used per mole of phenol. When low ratios of formaldehyde are used, tackifiers are formed. The existence of phenol-formaldehyde tackifiers are well known to the art and to the literature, e.g., “Resins Used in Rubbers” by Paul O. Powers, Rubber Chemistry and Technology, Vol. 36, Pages 1542 through 1562, (1963), and “Role of Phenolic Tackifiers in Polyisoprene Rubber,” by F. L. Mangus and G. R. Hamed, Rubber Chemistry and Technology, Vol. 64, Pages 65 through 73 (1991).

The amount of tackifying agent, when utilized, is typically from about 1 to about 30, desirably from about 2 to about 15, and preferably from about 6 to 10 phr.

The present invention relates to sulfur cure systems and include one or more cure accelerators in the adhesive cushion composition. Suitable amounts of sulfur and/or sulfur donor-type compounds generally range from about 1 to about 10 and preferably from about 2 to about 4 phr. The amounts of sulfur vulcanization accelerator generally range from about 0.2 to about 4 and preferably from about 0.5 to about 2.0 phr. Various sulfur accelerators can be used such as aldehyde-amine accelerators, e.g., the reaction product of butyraldehyde and aniline, amines such as hexamethylenetetramine, guanidines such as diphenylguanidine, thioureas, sulfenamides, and the like. Activators such as zinc oxide, stearic acid, litharge, magnesia and amines can also be used in conventional amounts to attain good crosslinking efficiency, such as in amounts of from about 0.5 to about 15 and preferably from about 1 to about 5 or 10 phr. Various oils such as naphthenic oils are commonly utilized in suitable amounts such as from about 1 to about 30 and desirably from about 4 to about 20 phr.

The solventless cushion layer can also include conventional amounts of various known rubber compounding ingredients such as processing aids, stabilizers, antidegradants, and the like. Suitable antioxidants include hindered phenols, amines, amino phenols, hydroquinones, alkyldiamines, amine condensation products and the like.

The uncured rubber cushion layer can be vulcanized by heat or radiation according to any conventional vulcanization process. Typically, the vulcanization is conducted at a temperature ranging from about 100° C. to about 180° C., alternately from about 120° C. to about 170° C. for a time period ranging from about 1 to about 300 minutes. The tire carcass, or casing, (also precured tread if used) being retreaded, having been previously been vulcanized, requires no additional vulcanization.

The present invention can be utilized to form a laminated retreaded tire for various types of vehicle tires such as passenger car tires, light and medium truck tires, off the road tires, and preferably is utilized in forming retreaded laminates for aircraft and medium truck tires.

Suitable tire tread compositions can be prepared by using conventional mixing techniques including, e.g., kneading, roller milling, extruder mixing, internal mixing (such as with a Banbury® mixing), etc. The sequence of mixing and temperatures employed are well known to skilled rubber compounders, the objective being the dispersion of fillers, activators, curatives in the polymer without excessive heat buildup.

The carcass cushion layer used in this invention in addition to forming retreaded tires, can generally be utilized to form a laminate between a tire tread and tire carcass casing when a good heat resistant, good blow-out protection (reduction or elimination of small internal voids formation within the rubber composition) is desired.

The following examples serve to illustrate the invention in detail but do not limit the same thereto. The amounts, or parts, are by weight unless otherwise indicated.

### EXAMPLE I

Rubber samples, representative of for tire cushion layer compositions to be positioned between a buffed tire rubber carcass and a rubber tire tread, are prepared as a black colored Control Sample A in a manner of the black colored cushion layer illustrated in the aforesaid U.S. Pat. No. 5,503,940, and Sample B representing a non-black, white colored cushion rubber composition of this invention. Ingredients for the respective Samples are illustrated in the following Table 1.

TABLE 1

| | Control | |
|---|---|---|
| Material | Sample A | Sample B |
| First Non-Productive Mixing | | |
| Polybutadiene rubber¹ | 60 | 60 |
| Natural rubber² | 40 | 40 |
| Carbon black³ | 50 | 0 |
| Titanium dioxide, rutile | 0 | 5 |
| Silica⁴ | 0 | 25 |
| Coupling agent⁵ | 0 | 2 |
| Processing oils | 6.5 | 6.5 |
| Stearic acid | 1 | 0 |
| Zinc oxide | 3.0 | 3.5 |
| Antidegradants⁶ | 2.5 | 2.5 |
| Octadedanoic acid | 1 | 1 |
| Tackifying resin⁷ | 8 | 8 |
| Bis-amide⁸ | 1.5 | 0 |
| Second Non-Productive Mixing | | |
| Silica⁴ | 0 | 25 |
| Coupling agent⁵ | 0 | 2 |
| Productive mixing | | |
| Sulfur | 3 | 3.5 |
| Accelerators (curing aids)⁹ | 4.5 | 6.7 |

¹Cis-1,4-polybutadiene as BUD1208 ™ from The Goodyear Tire & Rubber Company having high cis 1,4-content.
²Cis-1,4-polyisoprene natural rubber (SMR-20)
³N550, an ASTM designation
⁴Precipitated silica as HiSil ™ 243LD from PPG Industries Inc.
⁵A liquid silica coupling agent as a bis(3-triethoxysilylpropyl) polysulfide having an average of about 2.2 connecting sulfur atoms in its polysulfide bridge as Si266 ™ from the Degussa Company.
⁶Of the paraphenylene diamine type
⁷Phenol-formaldehyde type tackifying resin obtained as SP-1068 Resin ™ from the Schenectady Company
⁸N,N′-m-xylene bis-citraconic imide as Perkalink ™ 900 from the Flexsys B.V. Company.
⁹Accelerators as sulfenamide and diphenylguanidine types

### EXAMPLE II

A tire is prepared by application of an uncured, tacky, non-black, white colored circumferential rubber cushion layer of a rubber composition of Sample B of Example I herein to a cured tire rubber carcass from which its tread has been buffed away.

Over the cushion layer is applied a cured rubber tread strip.

The resulting tire assembly is placed in a suitable envelope (a well known method of retreading to those having skill in such art) where the tire assembly is cured under conditions of elevated temperature (e.g. 170° C.) and time to form a cured, retreaded tire.

The cushion layer acted as an intermediate transition laminate positioned between the uncured circumferential tire carbon black reinforced rubber tread and the buffed supporting toroidal shaped pneumatic tire cured carbon black reinforced rubber carcass, wherein said uncured rubber cushion provided an adhesive bond between said circumferential tire tread and supporting tire carcass.

The non-black, white colored intermediate transition rubber cushion laminate, by the nature of its non-black color, provided a color based monitoring means for controlling a subsequent abrading away of said cured rubber tread and at least a portion of said cushion laminate.

In such manner, the resulting tire is then retreaded buy the steps of:
(A) mounting said cured tire assembly on a suitable apparatus for rotation about its center axis;
(B) inflating the tire with air under pressure greater than ambient atmospheric pressure;
(C) abrading away the tire tread and a portion of said intermediate cushion rubber laminate layer while rotating said tire about its axis and applying a grinding wheel against the tread and then the cushion layer;
(D) wherein said abrading away of the intermediate cushion rubber laminate layer is accomplished by controlling the degree of its abrasive removal by monitoring the presence of its white color by a color-sensing apparatus to control the extent of its abrasive removal to thereby prevent its complete removal from said tire carcass;
(E) application of an uncured, tacky, non-black, white colored rubber cushion layer of a rubber composition of Sample B of Example I herein to said remaining cured cushion laminate layer to re-create an intermediate cushion layer over which is applied an uncured circumferential carbon black reinforced rubber tread wherein said uncured cured rubber cushion provides an adhesive bond between said circumferential tire tread and supporting tire carcass, followed by:
(F) curing said prepared tire assembly at an elevated temperature in a suitable mold to form said retreaded tire.

While certain representative embodiments and details have been shown for the purpose of illustrating the invention, it will be apparent to those skilled in this art that various changes and modifications may be made therein without departing from the spirit or scope of the invention.

1. A method of preparing a tire comprises the steps of:
(A) preparing a tire assembly by application of an uncured, tacky, non-black colored rubber carcass cushion layer as an intermediate transition laminate positioned between an uncured circumferential tire carbon black reinforced rubber tread and a supporting toroidal shaped, carbon black reinforced pneumatic tire rubber carcass, wherein said uncured rubber cushion provides an adhesive bond between said circumferential tire tread and supporting tire carcass, followed by;
(B) curing said prepared tire assembly at an elevated temperature in a suitable mold to form said tire.

2. The method of claim 1 wherein said method, by the nature of said non-black colored intermediate transition rubber carcass cushion laminate, further provides a means of abrading away of said circumferential tire tread a combination of color-based monitoring and controlling an abrading away of a portion of said underlying carcass cushion laminate.

3. A tire prepared by the method of claim 1.

4. A tire comprised of a carbon black reinforced, thereby black colored, rubber carcass and circumferential carbon black reinforced, therefore black colored, rubber tire tread characterized in that said tire contains a means of controllably determining a complete removal of said tire tread wherein said means consists of an inclusion of a color-detectable circumferential non-black colored rubber carcass cushion laminate between said tire carcass and said tire tread.

5. The tire of claim 4 wherein one or more circumferential cord reinforced rubber ply (plies) is (are) positioned between said tread and said carcass cushion layer.

6. The tire of claim 4 wherein said tire tread is of a co-extruded cap/base construction where the tread cap rubber layer contains a running surface of the tire and the tread rubber base layer underlies the tread cap layer.

7. A method of retreading the cured pneumatic rubber tire of claim 1 which comprises the steps of:
(A) mounting said cured pneumatic tire comprised of said black colored circumferential rubber tread, non-black-colored rubber carcass cushion layer laminate underlying said tread, and black colored tire rubber carcass on a suitable apparatus for rotation about its center axis;
(B) inflating the tire with fluid (e.g. air) under pressure greater than ambient atmospheric pressure;
(C) removing the entire circumferential tire tread and partially removing a portion of said non-black colored carcass cushion layer while rotating said tire about its axis;
(D) wherein the extent of said partial removal of said of said carcass cushion rubber layer is controlled by a combination of detecting the presence of the non-black color thereof by a color-sensing means and monitoring the extent of its removal to thereby prevent its complete removal from said tire carcass;
(E) applying an additional uncured, tacky, non-black colored rubber carcass cushion layer to the radially outer surface of said partial remaining cured carcass cushion layer on said tire carcass to form a built-up carcass cushion layer dual laminae comprised of a laminate of said uncured cushion layer over said cured carcass cushion layer;
(F) applying an uncured circumferential carbon black reinforced, black colored rubber tread to the radially outer surface of said uncured non-black colored carcass cushion layer of said carcass cushion layer dual laminae to form a tire assembly followed by:
(G) curing said prepared tire assembly at an elevated temperature in a suitable mold to form said retreaded tire.

8. A retreaded tire prepared by the method of claim 7.

9. A method retreading the tire of claim 8 wherein said method is comprised of removing the entire circumferential black colored rubber tire tread followed by a combination of sensing the underlying non-black colored carcass cushion layer and controlling the degree of partial removal of said non-black colored carcass cushion layer in a manner to prevent a complete removal of said carcass cushion layer.

10. The method of claim 1 wherein said rubber composition of said carcass cushion layer is comprised of at least one diene-based elastomer, reinforcing filler as a precipitated silica, carbon black-free coupling agent for said silica and a pigment based non-black colorant comprised of titanium dioxide inorganic pigment and wherein said rubber composition is exclusive of carbon black.

11. The tire of claim 3 wherein said rubber composition of said carcass cushion layer is comprised of at least one diene-based elastomer, reinforcing filler as a precipitated silica, carbon black-free coupling agent for said silica and a pigment based non-black colorant comprised of titanium dioxide inorganic pigment and wherein said rubber composition is exclusive of carbon black.

12. The method of claim 6 wherein said rubber composition of said carcass cushion layer is comprised of at least one diene-based elastomer, reinforcing filler as a precipitated silica, carbon black-free coupling agent for said silica and a pigment based non-black colorant comprised of titanium dioxide inorganic pigment and wherein said rubber composition is exclusive of carbon black.

13. The tire of claim 7 wherein said rubber composition of said carcass cushion layer is comprised of at least one diene-based elastomer, reinforcing filler as a precipitated silica, carbon black-free coupling agent for said silica and a pigment based non-black colorant comprised of titanium dioxide inorganic pigment and wherein said rubber composition is exclusive of carbon black.

14. The method of claim 1 wherein said non-black colored cushion layer is a rubber layer is a laminate exclusive being co-extruded with said tire tread.

15. The tire of claim 5 wherein said non-black colored cushion layer is a rubber layer is a laminate exclusive being co-extruded with said tire tread.

16. The method of claim 6 wherein said non-black colored cushion layer is a rubber layer is a laminate exclusive being co-extruded with said tire tread.

17. The tire of claim 7 wherein said non-black colored cushion layer is a rubber layer is a laminate exclusive being co-extruded with said tire tread.

18. A method of retreading the pneumatic rubber tire of claim 6 which comprises the steps of:
(A) mounting said cured pneumatic tire comprised of said black colored circumferential rubber tread, non-black-colored rubber carcass cushion layer laminate underlying said tread, and black colored tire rubber carcass on a suitable apparatus for rotation about its center axis;
(B) inflating the tire with fluid (e.g. air) under pressure greater than ambient atmospheric pressure;
(C) removing the entire circumferential tire tread and partially removing a portion of said non-black colored carcass cushion layer while rotating said tire about its axis;
(D) wherein the extent of said partial removal of said of said carcass cushion rubber layer is controlled by a combination of detecting the presence of the non-black color thereof by a color-sensing means and monitoring the extent of its removal to thereby prevent its complete removal from said tire carcass;
(E) applying an additional uncured, tacky, non-black colored rubber carcass cushion layer to the radially outer surface of said partial remaining cured carcass cushion layer on said tire carcass to form a built-up carcass cushion layer dual laminae comprised of a laminate of said uncured cushion layer over said cured carcass cushion layer;
(F) applying an uncured circumferential carbon black reinforced, black colored rubber tread to the radially outer surface of said uncured non-black colored carcass cushion layer of said carcass cushion layer dual laminae to form a tire assembly followed by:
(G) curing said prepared tire assembly at an elevated temperature in a suitable mold to form said retreaded tire.

19. A retreaded tire prepared by the method of claim 18.

20. A method retreading the tire of claim 19 wherein said method is comprised of removing the entire circumferential black colored rubber tire tread followed by a combination of sensing the underlying non-black colored carcass cushion layer and controlling the degree of partial removal of said non-black colored carcass cushion layer in a manner to prevent a complete removal of said carcass cushion layer.
